(19) United States
(12) Patent Application Publication
(10) Pub. No.: US 2009/0003411 A1
(43) Pub. Date: Jan. 1, 2009

(54) HIGH-TEMPERATURE SENSING SYSTEM WITH PASSIVE WIRELESS COMMUNICATION

(76) Inventor: Felix J. Schuda, Saratoga, CA (US)

Correspondence Address: WESTMAN, CHAMPLIN & KELLY, P.A., Suite 1400, 900 Second Avenue South, Minneapolis, MN, 55402-3319, US

(21) Appl. No.: 12/132,822

(22) Filed: Jun. 4, 2008

Related U.S. Application Data
(60) Provisional application No. 60/933,169, filed on Jun. 5, 2007.

(51) Int. Cl. G01K 1/20; G01D 7/00

(52) U.S. Cl. 374/186; 73/866.1; 374/E01.004

(57) ABSTRACT

A high-temperature sensing system for sensing at least one parameter of interest within a high-temperature environment is provided. The system includes a substrate having at least one electrical network disposed thereon. Each of the at least one electrical network is a tuned circuit having a resonant frequency, and a temperature sensitive electrical component that varies the resonant behavior of the tuned circuit with a parameter of interest. An antenna is disposed to interact with the at least one electrical network. Transmit/receive electronics are spaced from the high-temperature environment and coupled to the antenna. The transmit/receive electronics are configured to generated selected drive signals to address each of the at least one electrical network and to detect a modulated radio-frequency reflection. A processor is coupled to the transmit/receive electronics and configured to calculate a parameter of interest for each detected modulated radio-frequency reflection.

### CROSS REFERENCE TO RELATED APPLICATION

The present application is based on and claims the benefit of U.S. provisional patent application Ser. No. 60/933,169, filed Jun. 5, 2007, the content of which is hereby incorporated by reference in its entirety.

### BACKGROUND

Semiconductor processing systems are characterized by extremely clean environments, extremely precise semiconductor wafer movement, and exacting control of relevant variables within the system. For example, many semiconductor processes depend critically on knowing temperature of the semiconductor substrate (wafer) as well as temperature gradients across the wafer surface during processing.

Instruments exist that measure temperatures at various points on wafer-like substrates and either store the data for later retrieval, or transmit the data via radio-frequency communication. However, since these instruments contain electronics, they are often limited in the maximum temperature to which they can be exposed, and measure. This maximum temperature is usually somewhere in the range of 50-150 degrees Celsius. However, since many semiconductor processes take place at temperatures above 500 degrees Celsius, the low temperature data from such instruments is often not useful.

There is a class of instruments that can withstand and measure the higher temperatures of semiconductor processes. However, these instruments generally require a wire, fiber optic coupling, or other hard connection to external electronics. This hard connection to external electronics is also of limited usefulness because it requires the user to open the semiconductor tool and manually insert the instrument. Moreover, any movement of the instrument within the semiconductor processing chamber will be constrained, to some extent, by the hard connection.

Providing a wireless sensing system for use in environments, such as a semiconductor processing chamber, that could accurately measure or otherwise transduce important variables relative to semiconductor processing would represent a significant advance in the art.

### SUMMARY

A high-temperature sensing system for sensing at least one parameter of interest within a high-temperature environment is provided. The system includes a substrate having at least one electrical network disposed thereon. Each of the at least one electrical network is a tuned circuit having a resonant frequency, and a temperature sensitive electrical component that varies the resonant behavior of the tuned circuit with a parameter of interest. An antenna is disposed to interact with the at least one electrical network. Transmit/receive electronics are protected from the high-temperature environment and coupled to the antenna. The transmit/receive electronics are configured to generate radio-frequency power that interacts with the network(s) and detects a change in reflected radio-frequency characteristics caused by each network. A processor is coupled to the transmit/receive electronics and configured to calculate a parameter of interest for each detected modulated radio-frequency reflection.

### BRIEF DESCRIPTION OF THE DRAWINGS

FIG. 1 is a diagrammatic view of a high-temperature wireless sensing system in accordance with an embodiment of the present invention.

FIG. 2 is a block diagram of a method of measuring a plurality of variables of interest in a semiconductor processing environment in accordance with an embodiment of the present invention.

FIG. 3 is a diagrammatic view of transmit/receive electronics coupled to an antenna in accordance with an embodiment of the present invention.

### DETAILED DESCRIPTION

Embodiments of the present invention generally employ high-temperature compatible passive components or carefully designed high-temperature active components. At least one electrical network is constructed from the passive components and includes a passive component that has an electrical characteristic that varies with a parameter of interest, such as temperature. The electrically-varying component changes the resonant frequency of the electrical network to which it is coupled. Embodiments of the present invention do not include electrical devices that store energy in the form of chemical potential energy, such as batteries. Instead, an antenna coupled to suitable transmit/receive circuitry generates a radio-frequency signal, or energy, that excites the at least one passive network, which resonates at a frequency that is related to the parameter of interest. The resonance of the at least one passive network then generates radio-frequency signal, which are detected through the antenna or other suitable wireless techniques. Thus, the device provides, essentially, a reflection that is based upon the parameter of interest. Embodiments generally include a number of such networks and much of the disclosure will be described with respect to a temperature-sensitive embodiment. However, embodiments of the present invention include utilization of any suitable detector that includes passive components or suitably designed high-temperature active components to vary an electrical characteristic, within an electrical network, with a parameter of interest. Such devices can include resistance temperature devices (RTDs), accelerometers, inclinometers, compasses, light detectors, pressure detectors, electric field strength detectors, magnetic field strength detectors, acidity detectors, acoustic detectors, humidity detectors, chemical moiety activity detectors, etc. Additionally, given that a specific passive network will generally be constructed from a combination of resistance, capacitive, and inductive components, any of the above detectors that provides either a resistance, capacitance, or inductance that varies with the parameter of interest can be employed in accordance with embodiments of the present invention.

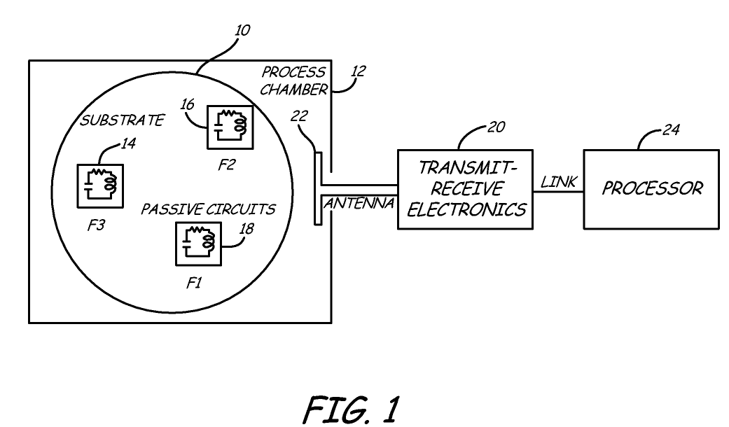

FIG. 1 is a diagrammatic view of a high-temperature wireless sensing system in accordance with an embodiment of the present invention. FIG. 1 illustrates substrate 10 located within a semiconductor processing chamber 12 having temperature-sensitive RF networks 14, 16, and 18. Preferably, the electrical components employed by networks 14, 16, and 18 are comprised of only passive components such as resistors, capacitors, and inductors. Further, these passive components are preferably constructed of high-temperature materials. Substrate 10 is illustrated as being circular, but can take any suitable size and/or shape that is useful. Substrate 10 is preferably constructed from a ceramic plate with capacitors and inductors made from ceramics and high-temperature metallic connections. At various locations on substrate 10, passive networks 14, 16, and 18 are arranged to “reflect” radio-frequency signals. Each of networks 14, 16, and 18 is preferably a simple RLC network, but may be more complex in accordance with embodiments of the present invention. Each network 14, 16, 18 contains an electrical component that changes its electrical parameter (R, C, or L) as the variable of interest (such as temperature) of the substrate changes. The varying electrical characteristic of a component in each network changes the behavior of that circuit.

An RLC circuit is also known as a resonant or tuned circuit. Such a circuit generally consists of a resistor, an inductor, and a capacitor, connected in series or in parallel. The arrangement creates a harmonic oscillator where the natural frequency of the oscillation is determined by the values of the resistor, inductor, and capacitor. If one of the components has a characteristic that varies with temperature, while the other components retain their fixed values, then the overall tuning of the RLC network will vary with temperature. Preferably, each network 14, 16, 18 is tuned by virtue of selection of the non-sensitive components to have a slightly different frequency such that the variation of the individual networks with their respective parameters of interest will not cause any overlap. The undamped natural frequency, or resonance, of an RLC circuit is expressed (in radians per second) by:

ψ₀=1/(√LC).

The damping factor for a series RLC circuit is expressed as:

ζ_{N}=(R√C)/(2√L)

The damping factor for a parallel RLC is expressed as:

ζ_{N}=(√L/(2R√C))

As used herein, the term “radio-frequency reflection” is intended to mean any method or technique for an external radio-frequency field to be able to obtain the resonant frequency of the network. This may be inductive coupling, back scatter modulation, or any other suitable means. In general, the excitation radio-frequency signal will be set at the nominal resonant frequency for a selected network, and pulsed, or otherwise driven, to cause the selected network to resonate. The selected network will then resonate at a nearby frequency that is shifted from the nominal frequency by a value that is related to the parameter of interest, such as temperature. The nominal frequency of each network is selected so that there is no overlap under any condition of the various parameters of interest.

Transmit/receive electronics 20 is coupled to antenna 22 disposed within, or proximate process chamber 12 and, preferably, sequentially probes each network 14, 16, 18 to determine its exact frequency. As used herein, “antenna” is intended to include any suitable device or arrangement for interacting with a radio-frequency field, such as a coil. Since each network changes frequency as the parameter of interest changes, transmit/receive electronics 20 can determine a parameter of interest for each network. In the case of temperature, the networks being positioned at different locations on substrate 10 allows various points on substrate 10 to have their temperature measured in order to generate a temperature map of substrate 10. Transmit/receive electronics 20 then transmits data to processor 24 so that a user can see the various parameter(s) of interest. The link to processor 24 can be via radio-frequency communication such as that in accordance with any suitable wireless communication standards currently set forth as IEEE802.11g; IEEE802.11n; a Bluetooth Specification, such as Bluetooth Core Specification Version 1.1 (Feb. 22, 2001), available from the Bluetooth SIG (www.bluetooth.com); or the known ZigBee specification operating at 915 MHz in the United States, and based on IEEE 802.15.4-2003. Alternatively, the link to processor 24 can be via a hard-wired connection such as an Ethernet connection, or any other suitable connection. Processor 24 can also be integrated into transmit/receive electronics 20 itself.

As illustrated in FIG. 1, transmit/receive electronics 20 may be disposed outside chamber 12, but coupled to antenna 22 disposed therein. Alternatively, transmit/receive electronics 20 may be disposed within chamber 12 in an area that is protected from high temperature. Transmit/receive electronics 20 emits an RF signal through antenna 22 and then determines a received RF reflection through antenna 22 to determine the resonant frequency of a selected network on substrate 10.

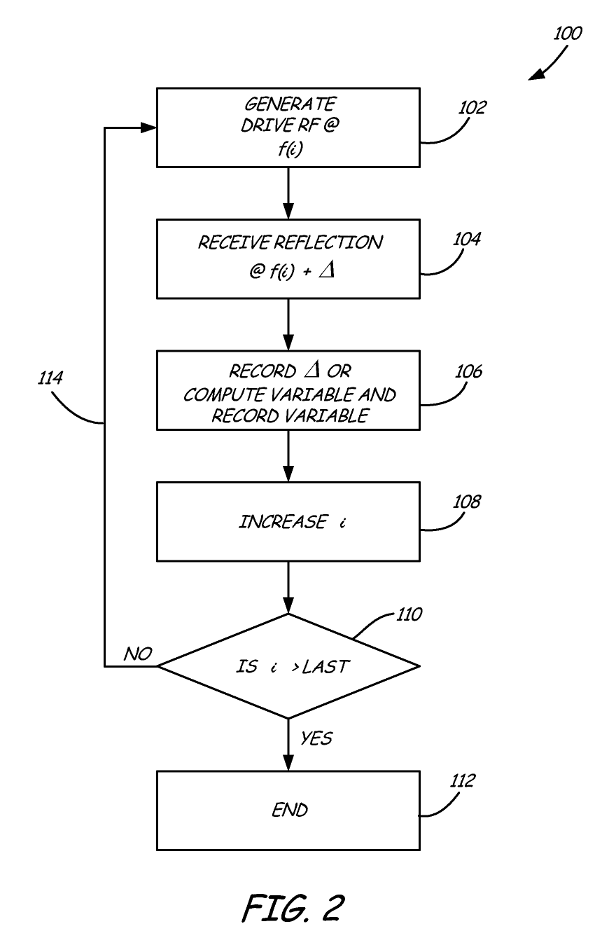

FIG. 2 is a block diagram of a method of measuring a plurality of variables of interest in a semiconductor processing environment in accordance with an embodiment of the present invention. For each tuned network on the wireless sensor, there will be a nominal frequency to uniquely address that network. These frequencies are stored, or otherwise maintained, such that they can be generated by transmit/receive electronics 20. When method 100 begins, index (i) is initially set at 1. Then, at block 102, transmit/receive electronics 20 will generate the drive radio-frequency signal at the frequency that is the nominal for the first network (f(1)). Then, during block 104, while the drive radio-frequency signal is being applied at the nominal frequency for the first tuned network, transmit/receive electronics 20 will detect the reflected radio frequency signal plus some change to that signal indicated in FIG. 2 as Δ. In the simplest embodiments, this change is simply a change in frequency compared to the drive radio frequency. This is a form of frequency modulation. However, other modulation such as amplitude modulation, pulse width modulation, et cetera may be used in accordance with embodiments of the present invention. Next, at block 106, the change (Δ) detected by the transmit/receive electronics 20 is either recorded directly, for later calculation, or used to calculate the process variable that corresponds with the Δ, at which point the process variable is recorded. For example, in the case of a network being a simple RLC network with a resistive component that varies with temperature (such an RTD) the reflection will be changed, to some extent, from the based upon a change in temperature. For example, the damping factor will change. In the case of a capacitive or inductive component that changes with the parameter of interest, both the resonant frequency and the damping factor will change. This change is thus directly related to the electrical change of the parameter-sensitive component. Accordingly, either the network's behavior as evidenced through the reflection can be recorded at block 106 or the change can be used to directly calculate the parameter of interest, such as temperature, and the parameter can then be recorded. Next, at block 108, the index (i) is incremented, and control passes to block 110 where method 100 determines whether the incremented i value is greater than the number of networks to be probed. If that is the case, method 100 ends at block 112. However, if there are additional networks to be probed, control returns, via line 114, to block 102 and the method iterates with the incremented i value causing transmit/receive electronics to generate a drive frequency at the nominal drive value for the next network such as f(2).

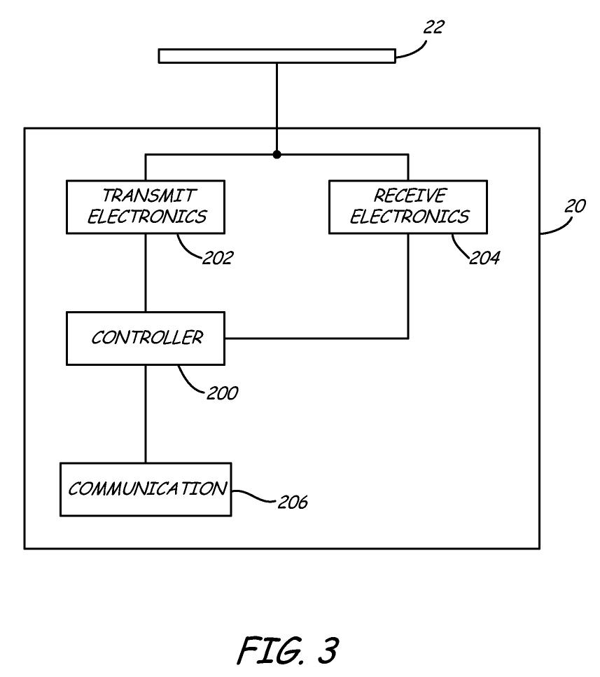

FIG. 3 is a diagrammatic view of transmit/receive electronics 20 coupled to antenna 22 in accordance with embodiments of the present invention. As set forth above, transmit/receive electronics 20 may be disposed within chamber 12, within an area that is protected from high temperature or outside chamber 12 and coupled to antenna 22 through a chamber wall. Additionally, antenna 22, itself, can be positioned outside of chamber 12 as long as there is a radio-frequency window, or other passageway, into chamber 12 through which the radio-frequency interaction between the various networks on substrate 10 and antenna 22 can occur. Transmit/receive electronics 20 includes a controller 200 coupled to transmit electronics 202 and receive electronics 204. Each of transmit electronics 202 and receive electronics 204 is coupled to antenna 22. However, embodiments of the present invention can be practiced with each of transmit electronics 202 and receive electronics 204 being coupled to different antennas. Transmit electronics 202 receives a signal from controller 200, such as a digital word or other suitable data that is indicative of a radio-frequency signal to generate. Transmit electronics 202 provides an output through antenna 22 that is based on the input from controller 200. As set forth above with respect to FIG. 2, various different radio-frequency drive signals are generated in order to probe selected networks. As illustrated in FIG. 3, receive electronics 204 is also coupled to controller 200. Preferably, this coupling is a bi-directional digital connection such that controller 200 can provide receive electronics with an indication relative to the drive signal generated by transmit electronics 202. In this way, receive electronics can tune itself to the drive frequency emitted by transmit electronics 202 in order to more quickly scan, or otherwise detect the modulation generated by the selected network via its radio-frequency reflection. However, receive electronics 204 can also be simply configured to scan through a variety of frequencies and detect the reflection on its own. Since the drive radio-frequency signal of transmit electronics 202 will be quite strong, receive electronics 204 can simply look for the second strongest signal as the reflected signal. Moreover, receive electronics 204 can be adapted, through software, hardware, or a combination thereof, to detect the other types of modulation, such as amplitude modulation, pulse width modulation, et cetera. Once receive electronics 204 detects the reflected radio-frequency signal, it provides an indication thereof to controller 200. Controller 200 can then transmit data to an external device, such as processor 24 via communication interface 206. Alternatively, controller 200 may calculate the parameter of interest, such as temperature, and communicate that parameter to processor 24 via communication module 206. Communication module 206 can be any suitable device that allows digital communication with processor 24. For example, communication module 206 can be an Ethernet module, a Wi-Fi module, a Bluetooth module, a serial communication link such as RS232 or USB, et cetera.

While embodiments of the present invention have generally been described with respect to measuring temperature of a semiconductor wafer in a process chamber, other types of physical conditions can be measured besides temperature. Additionally, the substrate can be a silicon wafer that is processed to actually contain the circuits comprising various networks. Further, in some cases, active components may be added to one or more of the networks if such active components can be fabricated from suitably high-temperature materials such as silicon carbide. However, embodiments of the present invention generally do not include any power source on the substrate and the embodiments generally function by modulating or changing the externally applied radio-frequency signal. In this manner, no battery chemistry, such as nickel-cadmium or lithium ion, is exposed to the high-temperature (such as 500 degrees Celsius) processing environment which could damage such a battery, or cause a battery to explode, thereby contaminating the entire processing environment.

One advantage of embodiments of the present invention is that temperature measurements can be performed at temperatures far above those available with sensors that employ active networks. Additionally, embodiments of the present invention also allow for networks that are more robust and can withstand strong chemicals and hostile environments. Multiple substrates can be probed by the same transmit/receive electronics so that changing the substrate configuration does not require changing the electronics. Thus, a first substrate can be used to measure temperatures, a second substrate can be used to measure a different variable such as chemical composition or magnetic field strength, et cetera. As illustrated in FIG. 1, the substrate is not physically connected to other devices and can therefore be moved through the system, such as the semiconductor processing system, with standard semiconductor processing robots.

All embodiments of the present invention have generally been described with respect to a sensor for wirelessly sensing parameters of interest within a semiconductor processing chamber. However, embodiments of the present invention can be used to provide sensors that are useful in other industries. For example, embodiments of the present invention can be miniaturized and constructed with bio-implantable materials such that an sensor can be implanted within a human body that is able to provide parameters of interest relative to the body when interrogated by the external radio-frequency drive signal. Additionally, active components can be made part of the networks as long as the networks continue to communicate by reacting to an externally applied field.

Although the present invention has been described with reference to preferred embodiments, workers skilled in the art will recognize that changes may be made in form and detail without departing from the spirit and scope of the invention.

1. A high-temperature sensing system for sensing at least one parameter of interest within a high-temperature environment, the system comprising:
a substrate having at least one electrical network disposed thereon, each of the at least one electrical network being a tuned circuit having a resonant frequency, and a temperature sensitive electrical component that varies the resonant behavior of the tuned circuit with a parameter of interest;
an antenna disposed to interact with the at least one electrical network;
transmit/receive electronics spaced from the high-temperature environment and coupled to the antenna, the transmit/receive electronics being configured to generated selected drive signals to address each of the at least one electrical network and to detect a modulated radio-frequency reflection; and
a processor coupled to the transmit/receive electronics and configured to calculate a parameter of interest for each detected modulated radio-frequency reflection.

2. The system of claim 1, wherein the parameter of interest includes temperature.

3. The system of claim 2, wherein the at least one electrical network comprises a plurality of electrical networks disposed on the substrate, each network being configured to provide a modulated radio-frequency reflection indicative of a respective parameter of interest.

4. The system of claim 3, wherein the plurality of electrical networks are isolated from one another.

5. The system of claim 1, wherein the at least one electrical network comprises a plurality of electrical networks disposed on the substrate and isolated from each other, each network being configured to provide a modulated radio-frequency reflection indicative of a respective parameter of interest.

6. The system of claim 1, wherein the processor is integrated with the transmit/receive electronics.

7. The system of claim 1, wherein the transmit/receive electronics are operably coupled to the processor through a communication link.

8. The system of claim 7, wherein the communication link is a wireless communication link.

9. The system of claim 8, wherein the wireless communication link is a ZigBee communication link.

10. The system of claim 7, wherein the communication link is a hard-wired communication link.

11. The system of claim 1, wherein each of the at least one electrical network is constructed solely from passive components.

12. The system of claim 1, wherein the modulated radio-frequency reflection is a frequency-modulated radio-frequency reflection.

13. The system of claim 1, wherein the modulated radio-frequency reflection is an amplitude-modulated radio-frequency reflection.

14. The system of claim 1, wherein the modulated radio-frequency reflection is a pulse width-modulated radio-frequency reflection.

15. The system of claim 1, wherein the modulated radio-frequency reflection has an oscillatory response with a damping factor that varies with a parameter of interest.

16. The system of claim 1, wherein the antenna is disposed within the high-temperature environment.

17. The system of claim 1, wherein the antenna is disposed external to the high-temperature environment proximate a radio-frequency window.

18. The system of claim 1, wherein the high-temperature environment is a semiconductor processing environment.

19. The system of claim 1, wherein the substrate is a semiconductor wafer.

20. The system of claim 19, wherein the at least one electrical network is fabricated on the semiconductor wafer.

21. The system of claim 1, wherein the transmit/receive electronics is a single, unitary component.

22. A high-temperature wireless sensor comprising:
a substrate;
a first electrical network forming a first tuned circuit having a nominal first tuned circuit resonant frequency, and at least one electrical component that is sensitive to a first parameter of interest, wherein the oscillatory behavior of the first tuned circuit varies with the first parameter of interest; and
a second electrical network isolated from the first electrical network and forming a second tuned circuit having a second nominal second tuned circuit resonant frequency, and at least one electrical component that is sensitive to a second parameter of interest, wherein the oscillatory behavior of the second tuned circuit varies with the second parameter of interest.

23. The high-temperature wireless sensor of claim 22, wherein the nominal first tuned circuit resonant frequency and the nominal second tuned circuit resonant frequency are spaced apart.

24. The high-temperature wireless sensor of claim 22, wherein the nominal first tuned circuit resonant frequency and the nominal second tuned circuit resonant frequency are spaced apart by a frequency separation greater than a maximum variation of each tuned circuit with the first and second parameters of interest.

25. A method of determining a parameter of interest within a high-temperature environment, the method comprising:
providing a substrate having at least one tuned circuit thereon, wherein the tuned circuit includes at least one passive electrical component that has an electrical characteristic that varies with the parameter of interest;
directing radio-frequency radiation at the substrate; and
detecting a radio-frequency reflection from the at least one tuned circuit, wherein the radio-frequency reflection includes a modulation that is based upon the parameter of interest.
